(19) United States
(12) Patent Application Publication
(10) Pub. No.: US 2008/0046166 A1
(43) Pub. Date: Feb. 21, 2008

(54) METHOD FOR DETECTING A DRIVING SITUATION AHEAD

(75) Inventors: Winfried FAKLER, Friedrichshafen (DE); Johannes Kaltenbach, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/770,021

(22) Filed: Jun. 28, 2007

(30) Foreign Application Priority Data
Jul. 1, 2006 (DE) 10 2006 030 527.2

(51) Int. Cl. G06F 19/00

(52) U.S. Cl. 701/117

(57) ABSTRACT

The invention relates to a method for detecting a driving situation ahead of a motor vehicle. In a first step, a first function (f_{—}1) is evaluated, which calculates a variable path length ahead (I_vor) as a function of a current vehicle speed (v) and a current degree of sportiness (gsp). In a second step, a second function (f_{—}2) is evaluated, which calculates the road course data (str_vor) at least as a function of the variable path length ahead (I_vor) and environment data (u). In a third step, a third function (f_{—}3) is evaluated, which calculates a possible driving situation ahead (sit_cand) at least as a function of the road course data (str_vor), the vehicle speed (v) and the degree of sportiness (gsp). Finally, in a fourth step, a fourth function (f_{—}4) is evaluated, by means of which a driving situation ahead (sit_vor) is detected at least as a function of the possible driving situation ahead (sit_cand). The detected driving situation ahead (sit_vor) can be used, for example, to influence electronic and/or mechanical vehicle systems, such as electronically controlled vehicle transmissions.

The invention relates to the predictive detection of driving situations located ahead for motor vehicles.

The unpublished application DE 10 2005 040 179.1 by the Applicant proposes a device for predictively determining a gear transmission ratio, wherein a correcting module is given a first proposed gear, drive/vehicle data as well as environment information about the current and anticipated driving environment. The environment data may be navigation data from navigation systems, by which a driving situation ahead is detected. Furthermore, the environment data may also be determined by environment sensors. In the correcting module, a driving situation is determined in a driving situation module from the data that is received. A driving situation corresponds, for example, to a curve ahead, the degree of curviness within a path ahead, a road gradient located ahead or a long straight path ahead. The application, however, does not explain how the driving situation located ahead is detected.

It is, therefore, the object of the present invention to enable a method for the predictive detection of a driving situation ahead.

This object is achieved with a method for detecting an anticipated driving situation in keeping with the characterizing features of the main claim; advantageous embodiments will be apparent from the dependent claims. With the help of the detected driving situation, advantageously electronic and/or mechanical vehicle systems can be influenced. In an advantageous embodiment, the method is used to influence a gear ratio in an electronically controlled transmission.

The method, according to the invention, presupposes a satellite-based navigation system. This system is either based on maps or comprises elsewhere electronically stored, location-specific data, such as that determined, for example, by learning systems. This location-specific data, also referred to as environment data, comprises information about the geometry of the road ahead, which is to say about the course of the road ahead or it comprises data from which information about the course of the road ahead can be calculated. Furthermore, it is necessary for the method that vehicle data, such as the vehicle speed and/or a signal which can be used to calculate the vehicle speed, is determined and made available.

The road course data describes, for example, the horizontal and/or vertical course of the path ahead. Taking this road course data and the vehicle data, particularly the vehicle speed, as well as the current degree of sportiness into consideration, the method through a function detects an anticipated driving situation, located ahead, within a variable path length of travel ahead for which the anticipated driving situation is supposed to be determined.

For this purpose, a function is defined for predictively determining the variable distance length of travel ahead, which is dependent at least upon the current vehicle speed and the current degree of sportiness. As a function of the current vehicle speed and the current degree of sportiness, the distance length of travel ahead can thus take on different values. The degree of sportiness typically provides information about the driving style of the driver. The degree of sportiness can be calculated either by an electronic system or it is defined by the driver through input, via a control element.

In one embodiment, additionally the validity of the present road course data is verified. The road course data is determined as a function of the variable distance length ahead and, furthermore, as a function of the environment data. If the present road course data is not valid, it is marked as invalid or is deleted.

In the event that either a relevant curve ahead or relevant curviness ahead is supposed to be detected as a relevant driving situation located ahead, advantageously the following criteria are taken into consideration. This means that either it is verified, in criterion 1, whether a projected future driving acceleration fulfills a transverse acceleration function, or it is verified, in criterion 2, whether the detected environment data fulfills a road course function. From the transverse acceleration function, an allowable transverse acceleration value is calculated as a function of the degree of sportiness and the vehicle speed. From the road course function, for example, a curve radius value is calculated as a function of the degree of sportiness and the vehicle speed. A curve is detected as being relevant if it meets one of the two criteria mentioned above.

In the event that a relevant curve ahead is supposed to be detected using the method, in one embodiment, a verification is carried out in a further step to determine whether the possible driving situation, detected by the function for detecting a driving situation, is in fact met. This function is referred to as a curve detection function, in this case. Whether the curve detection function is met will be verified as a function of the possible driving situation ahead, the vehicle speed and the road course data. If this is the case, the “curve detected” status is determined. In a further embodiment, a plausibility check of this verification can additionally be carried out with the help of further vehicle data.

For detecting a relevant curve ahead within the variable distance length of travel ahead, the curve detection function determines either the first, the tightest or the last curve within the variable distance length of travel ahead by way of criterion 1 or criterion 2.

During the verification to determine whether the conditions for a predictively determined curve in fact exist, advantageously the following steps are carried out. Starting from a first state, in which no curve is detected, it is evaluated whether the curve detection function is met. If this is the case, a second state is specified, which describes the situation that a curve ahead has been detected. In a subsequent step, it is then evaluated whether the second state has been specified, however the curve detection function is no longer met. If this is the case, a third state is specified, which prepares an exit from the second state. This exit is prepared such that a path, to be determined, is defined and must be followed. While following this path, that is to be determined, it is evaluated again whether the curve detection function is again met. If this is the case, the second status is specified again. If this is not the case, the first status is specified.

Optionally, the following further steps may be carried out. If the second state has been specified, however the curve ahead is evaluated as being invalid, a fourth state is assumed, which describes the situation that the detected curve is invalid. Thereafter, a safety path is determined, which the vehicle must follow and whereupon always the first state is specified. While following the safety path, the second state can no longer be specified. It is also possible to determine from the second state that a detected curve is invalid. Thereupon the fourth state is also specified, whereupon, as described above, the first state is always specified.

In the event that the method, according to the invention, is supposed to be used to detect the curviness of the path ahead, in a further embodiment all relevant curves within the variable length of travel ahead are determined with the corresponding function for detecting the upcoming driving situation. This function is referred to as a curviness function, in this case. The degree of curviness is derived from the sum of all detected relevant curves. The detected curves can be weighted in the order in which they were detected.

In a further embodiment, the degree of sportiness can also be represented by a fixed value. In one embodiment, the variable length of travel ahead, within which the anticipated driving situation is supposed to be determined, is limited toward the top and/or the bottom by at least one threshold value.

To further illustrate the method according to the invention, figures are attached to demonstrate the course of the method.

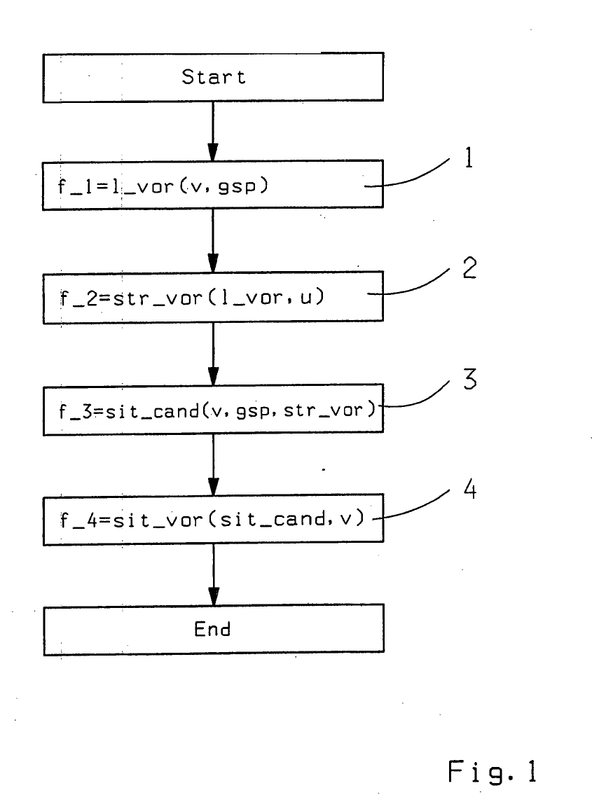

FIG. 1 is a flow chart for detecting an anticipated curve;

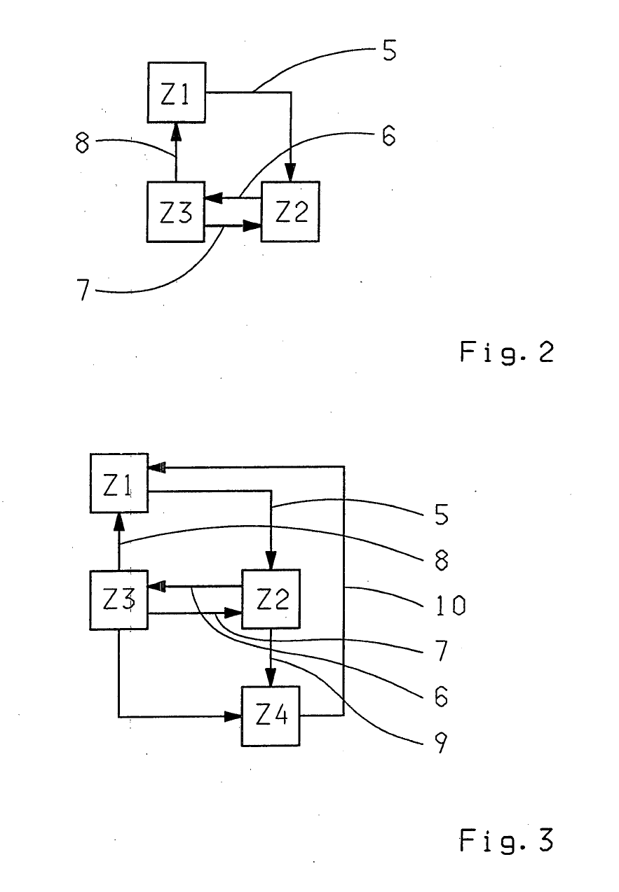

FIG. 2 is a flow chart of a substep, and

FIG. 3 is a flow chart of a further substep.

FIG. 1 shows a flow chart of an advantageous embodiment of the method, according to the invention, for detecting an upcoming or anticipated driving situation sit_vor curve. After starting the method in a first step 1, a first function f_1 is evaluated, which determines the variable length of travel ahead I_vor. The variable length of travel ahead I_vor describes the distance of the path ahead on which an anticipated driving situation sit_vor is supposed to be detected. The variable length of travel ahead I_vor depends on the vehicle speed v and the degree of sportiness gsp. In a second step 2, a second function f_2 is evaluated, by way of which, optionally, also the validity of the information about the path ahead is verified. For this purpose, the road course data str_vor is determined as a function of the variable length of travel ahead I_vor and, furthermore, as a function of the environment data u. If the available road course data str_vor comprises data, which was detected to be invalid, the data is assessed as invalid or is deleted in an optional step. In the next step 3, a third function f_3 is evaluated, which determines a possible driving situation ahead sit_cand. The possible driving situation ahead sit_cand depends on the road course data str_vor, the current vehicle speed v as well as the current degree of sportiness gsp. In the last step 4, it is verified by way of a fourth function f_4 whether the possible driving situation ahead sit_cand, such as a possible upcoming curve, in fact, exists and/or if all conditions for it have occurred. This is calculated by the anticipated driving situation sit_vor, which is determined as a function of the possible driving situation ahead sit_cand, the vehicle speed v and the road course data str_vor.

FIG. 2 shows the sequence of substeps of the last step 4, in which it is verified whether a predictively determined curve exists and/or whether the conditions for it have been met. The first state Z1 describes the situation that no curve is detected. If the curve detection function is met, based on a corresponding first piece of information 5, a second state Z2 is determined, which describes the situation that a curve sit_vor has been detected. If the curve detection function is no longer met, based on a corresponding second piece of information 6, a third state Z3 is determined. The third state Z3 determines the situation that an exit from the second state Z2 is being prepared. In order to prepare the exit from the second state Z2, it is specified that the motor vehicle must follow a path to be determined. If it is determined, while following this path to be determined, that the curve detection function is met again, the second state Z2 is again assumed, based on a corresponding third piece of information 7. If the curve detection function is no longer met while following the path, the first state Z1 is again assumed, based on a corresponding fourth piece of information 8, this state describing the situation that no curve is detected.

FIG. 3 shows the sequence of substeps of the last step 4, additionally, if the validity of the second state Z2 is checked. FIG. 3 corresponds to FIG. 2, with the addition of a fourth state Z4. Like elements from FIG. 2 are identified by like reference numerals and will not be described again. If the second state Z2 has occurred, however, the detected curve has been evaluated as invalid, the fourth state Z4 is specified, based on a corresponding fifth piece of information 9. The fourth state Z4 describes that the detected curve as implausible and, therefore, no curve is detected. After the fourth state Z4 has occurred, always the first state Z1 is adopted, based on a corresponding sixth piece of information 10, by following a safety path to be determined, this state describing that no curve is detected. While following this safety path to be determined, no further curve can be detected. From this third state Z3 also the fourth state may be assumed by a seventh piece of information 11.

Reference Numerals
1 first step
2 second step
3 third step
4 fourth step
5 first piece of information
6 second piece of information
7 third piece of information
8 fourth piece of information
9 fifth piece of information
10 sixth piece of information
11 seventh piece of information
f_1 first function
f_2 second function
f_3 third function
f_4 fourth function
gsp degree of sportiness
I_vor variable length of travel
sit_cand possible driving situation ahead
sit_vor anticipated driving situation
str_vor road course data
u environment data
v vehicle speed
Z1 first state
Z2 second state
Z3 third state
Z4 fourth state

1-11. (canceled)

12. A method for detecting an anticipated driving situation of a road in a motor vehicle, the method comprising the steps of:
calculating a variable length of travel ahead (I_vor) with a first function (f_1) based on a current vehicle speed (v) and a current degree of sportiness (gsp);
calculating a road course data (str_vor) with a second function (f_2) based at least on the variable length of travel ahead (I_vor) and environment data (u);
calculating a possible driving situation ahead (sit_cand) with a third function (f_) based at least on the road course data (str_vor), the vehicle speed (v) and the current degree of sportiness (gsp); and
detecting the anticipated driving situation (sit_vor) with a fourth function (f_4) based at least on the possible driving situation ahead (sit_cand), and
utilizing the detected anticipated driving situation (sit_vor) to influence at least one of an electronic vehicle system, a mechanical vehicle systems, and an electronically controlled vehicle transmissions.

13. The method according to claim 12, further comprising the step of further basing the third function (f_3) for detecting the possible driving situation ahead (sit_cand) on one of whether a projected future vehicle acceleration meets a dynamic transverse acceleration function and whether the detected road course data (str_vor) meets a dynamic road course function, if a degree of at least one curve ahead, within the variable length of travel ahead (I_vor), is supposed to be detected as the anticipated driving situation (sit_vor), the transverse acceleration function and the road course function being dependent at least on the current vehicle speed (v) and the current degree of sportiness (gsp).

14. The method according to claim 12, further comprising the step of basing the fourth function (f_4) on the possible curve ahead (sit_cand), the vehicle speed (v) and the road course data (str_vor) if anticipated driving situation (sit_vor) is supposed to be detected.

15. The method according to claim 14, further comprising the step of determining, with the third function (f_3), one of a first curve, a tightest curve and a last curve within the variable length of travel ahead (I_vor).

16. The method according to claim 12, further comprising the steps of:
evaluating in a first state (Z1), whether the anticipated driving situation (sit_vor) has been detected based on the road course data (str_vor);
evaluating, in a fifth state (5) during verification of the occurrence of a second state (Z2), whether the road course data (str_vor) and the anticipated driving situation (sit_vor) have been met, if so, the second state (Z2) is assumed;
evaluating a second piece of information (6), if the second state (Z2) is assumed, if the road course data (str_vor) is no longer met, then a third state (Z3) is assumed; and
evaluating in the third state (Z3), while following the road, whether the road course data (str_vor) is met again, if so, the second state (Z2) is again assumed, and, if not, the first state (Z1) is assumed.

17. The method according to claim 16, further comprising the step of verifying whether the second or third state (Z2, Z3) is valid, a fourth state (Z4) being assumed, if the second state (Z2) is invalid and thereupon the first state (Z1) being assumed again.

18. The method according to claim 12, further comprising the step of determining with the third function (f_3), for detecting the anticipated driving situation (sit_vor), all relevant curves within the variable length of travel ahead (I_vor) if, the degree of the anticipated driving situation (sit_vor) within the variable length of travel ahead (I_vor) is supposed to be detected.

19. The method according to claim 18, further comprising the step of calculating a degree of the anticipated driving situation (sit_vor) within the variable length of travel ahead (I_vor) from the sum of detected curves.

20. The method according to claim 12, further comprising the step of defining a fixed value with the degree of sportiness (gsp).

21. The method according to claim 12, further comprising the step of providing the variable length of travel ahead (I_vor) with at least one threshold value.

22. The use of a method according to claim 12, further comprising the step of influencing a gear ratio of an electronically controlled vehicle transmission with the detection of the anticipated driving situation (sit_vor).
